(19) United States
(12) Patent Application Publication
(10) Pub. No.: US 2010/0103692 A1
(43) Pub. Date: Apr. 29, 2010

(54) LAMP BASE, VEHICLE LAMP COMPRISING SUCH A BASE, AND METHOD FOR THE PRODUCTION OF A VEHICLE LAMP

(75) Inventor: Peter Helbig, Sontheim/Brenz (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/593,614

(22) PCT Filed: Mar. 27, 2008
(86) PCT No.: PCT/EP08/53674

§ 371 Date: Sep. 29, 2009

(30) Foreign Application Priority Data
Apr. 2, 2007 (DE) 10 2007 015 923.6

(51) Int. Cl. B60Q 1/00; H01J 9/395; H01J 9/00

(52) U.S. Cl. 362/548; 445/16; 445/22

(57) ABSTRACT

A lamp base for a vehicle lamp includes a base part from which contact tabs protrude for the purpose of electrical contacting and which carries a reference ring welded to an adjustment ring, a lamp bulb being placed onto the adjustment ring directly or via a fastening ring, wherein a weld metal zone of the welding between reference ring and adjustment ring is formed on rear surface sections facing away from the lamp bulb.

### TECHNICAL FIELD

The invention relates to a lamp base for a vehicle lamp, particularly a halogen lamp according to the preamble of patent claim 1, a vehicle lamp constructed with such a lamp base, and to a method for producing such a vehicle lamp.

In printed documents EP 0 775 366 B1 and DE 20 2006 002 888 U1, headlight lamps are described which, for example, can be used as daytime running light (DRL). Such headlight lamps constructed as incandescent halogen lamp have a lamp base into which an approximately cylindrical lamp bulb is inserted. In the internal space filled with a filling gas, encompassed by the lamp bulb, two coiled filaments are arranged, the filament exits of which are connected via molybdenum foils to current feeds which are carried out of a gastight squeeze-type seal of the lamp bulb. The current feeds are connected inside the base part to electrical terminals which protrude out of the base part as laterally projecting contact tabs and are brought into contact with contacts on the housing side when the headlight lamp is inserted into a headlight housing.

The lamp base of such incandescent lamps has a base part made of plastic which is welded to a reference ring. The reference ring, in turn, carries an adjustment ring. Both the reference ring and the adjustment ring have radially projecting lugs which, in the assembled state, rest against one another in the axial direction and are then joined by welding. The lamp bulb is inserted into a fastening ring which, in turn, is joined to the adjustment ring by welding, during which process a predetermined relative positioning must be set in order to align the coiled filaments of the headlight lamp with reference to the reflector so that an optimal light distribution is ensured. The welding between the adjustment ring and the reference ring is effected from the front, i.e. from the side of the lamp bulb, by means of laser energy. Since the lugs along which adjustment ring and reference ring are welded to one another protrude radially over the lamp bulb, the weld metal areas are visible from the front. This frequently leads to comments by the customers (car manufacturers) or the designers that these weld metal areas would disturb the aesthetic appearance of the headlight lamp or of the entire headlight. In practice, these criticisms must not be underestimated since visual aspects are frequently decisive for an order being granted, the technical quality being comparable.

### DESCRIPTION OF THE INVENTION

The invention is based on the object of creating a lamp base for a vehicle lamp, a vehicle lamp constructed with such a lamp base, and a method for producing a vehicle lamp which also meet high demands on the aesthetic appearance.

This object is achieved by the features of patent claim 1 with respect to the lamp base, by the features of patent claim 4 with respect to the vehicle lamp and by the features of the subordinate patent claim 5 with respect to the method. Particularly advantageous embodiments of the invention are described in the dependent claims.

The lamp base according to the invention for a vehicle lamp has a plastic base part from which contact tabs for electrical contacting project and which carries a reference ring joined to an adjustment ring. Onto the adjustment ring, a lamp bulb is placed directly or by means of a fastening ring. According to the invention, a weld metal zone of a welding between reference and adjustment ring is formed on rear surface sections of these rings, facing away from the lamp bulb.

In the vehicle lamp according to the invention, the lamp bulb is inserted into such a base with weld metal areas not visible from the front.

During the production of such a vehicle lamp, first the reference ring and the adjustment ring are preferably welded together from a rear facing away from the lamp bulb. Following this, the unit of reference ring and adjustment ring is put onto the base part.

Due to the welding from the rear, i.e. from the side facing away from the lamp base, the weld metal areas or welds are not visible from the front so that they do not impair the aesthetic appearance of the vehicle lamp.

Joining adjustment ring and reference ring is particularly simple if these are constructed in each case with radially projecting lugs along which the welding is effected.

The lugs formed on the reference ring are preferably constructed as reference lugs for positioning the vehicle lamp in a reflector.

In the production of the vehicle lamp, it is preferred if a fastening ring carrying the lamp bulb is fitted onto the adjustment ring, then the illuminant position is aligned and then the fastening ring is welded to the adjustment ring so that coiled filaments arranged in the lamp bulb are aligned precisely with respect to the reflector.

A laser welding method is preferably used for welding together the metallic components of the base.

### BRIEF DESCRIPTION OF THE DRAWINGS

In the text which follows, the invention will be explained in greater detail with reference to a preferred exemplary embodiment:

FIG. 1 shows a perspective representation of an H15 lamp of a vehicle headlight;

FIG. 2 shows a perspective representation of a reference ring and an adjustment ring seen from the rear;

FIG. 3 shows a view from the front of the lamp from FIG. 1;

FIG. 4 shows a perspective view of the adjustment ring and of the reference ring according to FIG. 2, and

FIG. 5 shows the adjustment ring and reference ring according to FIG. 2 with the base part positioned.

### PREFERRED EMBODIMENT OF THE INVENTION

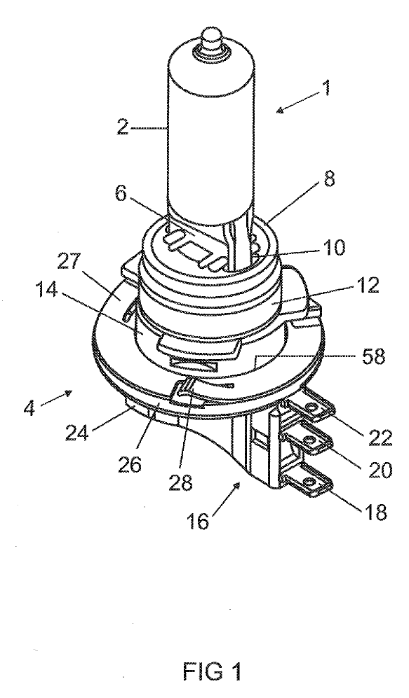

FIG. 1 shows a three-dimensional representation of a vehicle headlight lamp according to the invention which is constructed as H15-type incandescent halogen lamp 1. The structure of such an incandescent halogen lamp 1 or similar lamp types (e.g. H1, H3, H4 or H7 lamps) is known from the prior art initially mentioned so that only the components essential to the understanding of the invention will be described here.

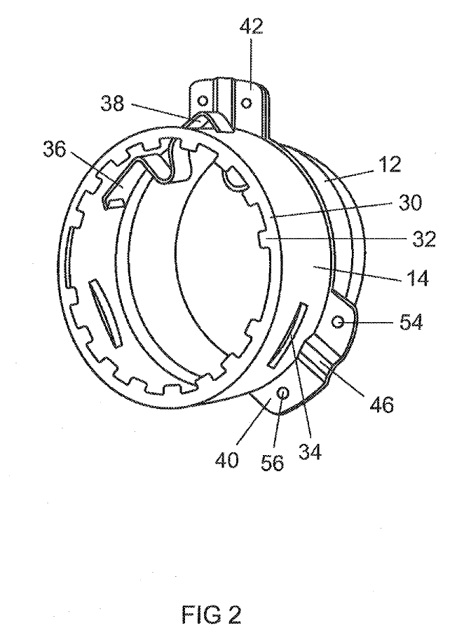

The incandescent halogen lamp 1 has an approximately cylindrical lamp bulb 2 which is inserted into a lamp base 4. The lamp bulb 2 is closed by a squeeze-type seal 6 towards the bottom (view according to FIG. 1) and filled with a filling gas which contains, in the case of halogen lamps, metal halides. In the case of an H15 lamp, two coiled filaments are arranged in the internal space of the lamp bulb 2, which, within the squeeze-type seal 6, are welded via molybdenum foils to current feeds which are brought in a sealing manner out of the squeeze-type seal 6 and project into the lamp base where they are welded to contact elements. The lamp base 4 has a metallic fastening ring 8 in which the squeeze-type seal 6 of the lamp bulb 2 is accommodated in a friction-locked and positive manner. For this purpose, the fastening ring 8 is constructed with a clamping recess 10, corresponding to the profiling of the squeeze-type seal 6, in which spring elements for clamping the squeeze-type seal 6 of the lamp bulb 2 are arranged. This fastening ring 8 is welded to an adjustment ring 12 which, in turn, is joined to a reference ring 14. The latter is placed onto a base part 16 consisting of plastic and welded to it. From the base part 16, three contact tabs 18, 20, 22 project in the radial direction, which, when the incandescent halogen lamp 1 is inserted into a car headlight, come into contact with holder contacts at the lamp reflector so that the lamp is mechanically held and contacted in the reflector. To provide for simpler handling of the incandescent halogen lamp 1, a diagonal web 24 is provided at the rear of the base part 16, i.e. at the end face remote from the lamp bulb 2, so that the torque required for fastening the incandescent halogen lamp 1 can be produced. The incandescent halogen lamp 1 is mounted in the holder of the reflector or of the headlight housing by means of a bayonet fitting, a spring ring 27 which has three spring tongues 28 protruding obliquely from the plane of the spring ring which, in the installed state of the incandescent halogen lamp 1, exert an axially directed spring force, being attached to the end face of a base flange 26. Further details of the adjustment ring 12 and of the reference ring 14 will be explained with reference to FIGS. 2 to 4.

FIG. 2 shows a three dimensional view of the reference ring carrying the adjustment ring 12, in a view seen from the base part 16. Accordingly, the reference ring 14 has a beaded end face 30 pointing toward the base part 16, at which a multiplicity of projections 32 protruding radially toward the inside is formed. At the circumferential wall of the reference ring 14, two impressions 34 are also provided which take into account any ridge present at the edge of the lamp assembly opening of the headlight as is disclosed, for example, in EP 1 006 550 A1. At the inside circumferential wall of the reference ring 14, a pressure spring 36 angled several times is attached which passes through a window in the circumferential wall of the reference ring 14 with a nose 38 angled in a V-shape. When the incandescent halogen lamp 1 is inserted, this nose 38 rests elastically against an internal circumferential wall of the holder and contributes to its positioning. The aforementioned protrusions 32 form a toothing via which the positioning and welding of the reference ring 14 to the base part 26 is facilitated.

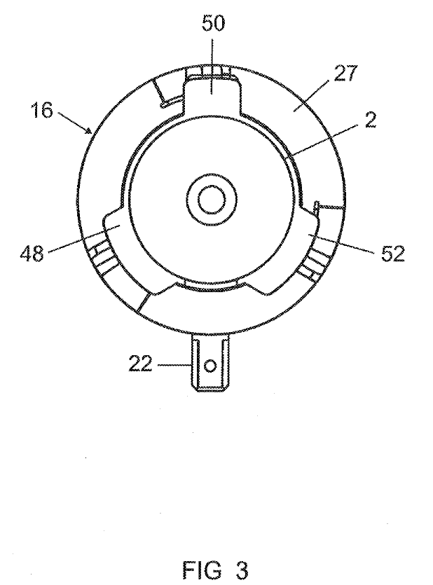

At the end section of the reference ring 14, pointing toward the adjustment ring 12, three reference lugs 40, 42 and 44 distributed on the circumference (see FIG. 3) are formed which are in each case provided with a corrugation 46 which is domed toward the base part. These reference lugs 40, 42, 44 are constructed in such a way that, when the incandescent halogen lamp 1 is inserted, they ensure a predetermined installed position within the holder, these reference lugs 40, 42, 44 resting against corresponding reference surfaces of the holder and thus determining the axial position and the position of the angle of rotation. The reference ring 14 can be produced, for example, by a deep-drawing process.

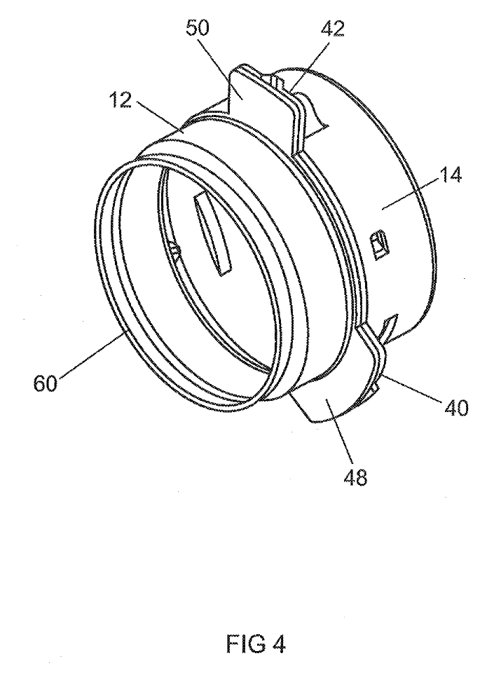

The adjustment ring 12 is placed onto the reference ring 14. As can be seen especially from FIG. 3, three lugs 48, 50, 52 are formed at the circumferential edge pointing toward the reference ring 14. The geometry of the lugs 48, 50 is adapted to that of the reference lugs 40, 42, 44 so that, in the installed position shown, the lugs 40, 42, 44 and 48, 50, 52 cover one another in pairs and rest against one another with their surfaces (see particularly FIG. 4). After this relative positioning of the two rings 12, 14, they are welded together along the lugs 40, 42, 44, 48, 50. This is preferably done by means of laser welding from the rear, i.e. from the base side, two welds 54, 56 which are arranged on both sides of corrugations 46 being provided at each lug 40, 42, 44, 48, 50. According to the representation in FIG. 3 which shows a front view of the incandescent halogen lamp 1 according to the invention from the lamp bulb 2, the dot-shaped welds 54, 56 are not visible from the front so that the aesthetic appearance is not disturbed. In conventional incandescent halogen lamps, the welds are in each case located at the front of the aforementioned lugs and would therefore be visible in a representation according to FIG. 3. Due to the measure according to the invention of carrying out the welding from the rear, the weld metal areas of the welds 54, 56 are virtually invisible so that the excellent operation of the incandescent halogen lamp 1 goes hand in hand with a high-quality appearance.

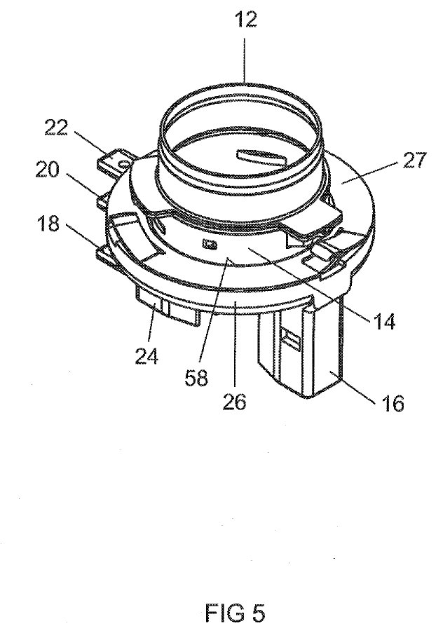

After the welding of the rings 12, 14, the reference ring 14 is inserted section by section into a receptacle 58 (see FIGS. 1 and 5) of the base part 16 provided with the spring ring 27 and joined, for example, by high-frequency welding.

As described initially, the lamp bulb 2 is inserted into the fastening ring 8. This preassembled unit is then placed onto the free, radially recessed end section 60 (see FIG. 4) of the adjustment ring 12 according to FIG. 1 and adjusted so that the coiled filaments are arranged in a predetermined axial and angular position. In a subsequent production step, the fastening ring 8 in its aligned position is then joined to the adjustment ring 12 by means of laser welding.

FIG. 5 shows the unit of adjustment ring 12 and reference ring 14 after the welding to the base part 16. As described in DE 20 2006 002 888 U1, mentioned initially, the diagonal web 24 is constructed with a removable locking part which cannot be seen in the representation according to FIG. 5. This locking part uncovers an opening through which the said current feeds can be welded to the ends of the contact tabs 18, 20, 22. After this welding, the locking piece is inserted so that the diagonal web 24 extends over the entire diameter of the base flange 26.

When the incandescent halogen lamp 1 is inserted into a headlight housing, an assembly receptacle of the reflector or of the housing is located between the reference lugs 40, 42, 44 and the spring tongues 28 so that the lamp is fastened in the axial direction. The support in the radial direction is provided by the nose 38 of the pressure spring 36 resting against the circumferential wall of the assembly receptacle.

A lamp base for a vehicle lamp, a vehicle lamp constructed with such a lamp base and a method for producing such a vehicle lamp are disclosed which essentially consists of a lamp bulb and a base part. The base part has an adjustment ring and a fastening ring which are welded together from a rear facing away from the lamp bulb.

1. A lamp base for a vehicle lamp, comprising:
a base part from which contact tabs protrude for the purpose of electrical contacting and which carries a reference ring welded to an adjustment ring, a lamp bulb being placed onto the adjustment ring directly or via a fastening ring, wherein a weld metal zone of the welding between reference ring and adjustment ring is formed on rear surface sections facing away from the lamp bulb.

2. The lamp base as claimed in claim 1, wherein adjustment ring and reference ring have radially projecting lugs aligned with one another, along which the welding is effected.

3. The lamp base as claimed in claim 2, wherein the reference lugs on the reference ring side are for the positioning when inserting the incandescent halogen lamp into an assembly receptacle.

4. A vehicle lamp, comprising:
a lamp base for a vehicle lamp, comprising:
a base part from which contact tabs protrude for the purpose of electrical contacting and which carries a reference ring welded to an adjustment ring, a lamp bulb being placed onto the adjustment ring directly or via a fastening ring, wherein a weld metal zone of the welding between reference ring and adjustment ring is formed on rear surface sections facing away from the lamp bulb; and
a lamp bulb filled with a filling gas, which is fused in a gastight manner and in which at least one filament is accommodated and which is inserted in the lamp base.

5. A method for producing a vehicle lamp, the vehicle lamp comprising:
a lamp base for a vehicle lamp, comprising:
a base part from which contact tabs protrude for the purpose of electrical contacting and which carries a reference ring welded to an adjustment ring, a lamp bulb being placed onto the adjustment ring directly or via a fastening ring, wherein a weld metal zone of the welding between reference ring and adjustment ring is formed on rear surface sections facing away from the lamp bulb; and
a lamp bulb filled with a filling gas, which is fused in a gastight manner and in which at least one filament is accommodated and which is inserted in the lamp base;
the method comprising:
placing the base part against the reference ring welded to the adjustment ring, and
together reference and adjustment ring from a rear side facing away from the lamp bulb,
placing the base part against the reference ring welded to the adjustment ring, and
fitting the lamp bulb.

6. The method as claimed in claim 5, the welding together of reference ring and adjustment ring being effected by means of laser welding.

7. The method as claimed in claim 5, wherein a fastening ring carrying the lamp bulb is fitted onto the adjustment ring, aligned and then welded to the latter.

8. The vehicle lamp as claimed in claim 4, being configured as an incandescent halogen lamp.
